(19) United States
(12) Patent Application Publication
(10) Pub. No.: US 2020/0286162 A1
(43) Pub. Date: Sep. 10, 2020

(54) METHOD AND SERVER FOR MANAGING SHARED VEHICLES

(71) Applicant: LAUNCH TECH CO., LTD., Shenzhen, Guangdong (CN)

(72) Inventors: Jun LIU, Shenzhen, Guangdong (CN); Xin LIU, Shenzhen, Guangdong (CN); Zhaohui GUO, Shenzhen, Guangdong (CN); Qingcai HUANG, Shenzhen, Guangdong (CN)

(21) Appl. No.: 16/061,334

(22) PCT Filed: May 31, 2018
(86) PCT No.: PCT/CN2018/089408

§ 371 Date: Jun. 11, 2018

(51) Int. Cl. G06Q 30/06; G06Q 20/40; G06Q 20/14; G06Q 10/02; H04L 9/06

(52) U.S. Cl. CPC G06Q 30/0645; G06Q 30/0621; G06Q 20/4014; H04L 2209/84; G06Q 10/02; H04L 9/0637; H04L 2209/38; G06Q 20/145

(57) ABSTRACT

A method and server for managing shared vehicles, the method comprising: receiving shared information and usage smart contract sent by a vehicle owner client; registering which in a block chain network and performing an entire network radio; receiving a rental request-sent by a rental client and registering the rental request into the block chain network; calculating a user grade of the user initiating the rental request according to a credit smart contract, searching matched shared vehicles; sending the matched shared vehicle to the rental client and the rental client determines a target shared vehicle; releasing usage authorization of the target shared vehicle to the rental client, so the vehicle owner obtains the real information of the user in time and knows the rental and service conditions of the shared vehicles in each time period, so that the vehicle owner shares their own vehicles to every service platforms relievedly.

### FIELD OF THE APPLICATION

The present application pertains to the technical field of vehicles, and particularly to a method and a server for managing shared vehicles.

### DESCRIPTION OF THE RELATED ART

With the concept of resource sharing continuously accepted by people, more and more enterprises begin to step in the field of resource sharing, such as sharing a bicycle, sharing an automobile and the like.

However, a sharing scheme implemented in some enterprises is not real resource sharing. Taking automobile rental enterprise as an example, the real purpose of resource sharing is sharing vehicles which are idle or not frequently used to the rental service platform, thereby implementing full utilization of the automobile resources and bring certain income to the vehicle owners. However, some owners are not willing to share their own vehicles to the rental service platform due to the fact that credit risks exist in the rental service platform, or because of some factors including nontransparent data in the transaction process. The rental service platform has to purchase vehicles themselves for outward renting, which not only increase an operation cost of the rental service enterprise, but also deviates the resource sharing deviates from its real intention.

### SUMMARY

In view of the above, the embodiments of the present application provide a method and server for managing shared vehicles, so as to solve the problem in the prior art that shared information of the shared platform is insufficient and can be tampered easily, result in the problem that the vehicle owners are not willing to share their vehicles.

The first aspect of embodiments of the present application provides a method for managing shared vehicles comprising:
receiving shared information and a usage smart contract sent by a vehicle owner client;
registering the shared information and the usage smart contract into a block chain network and radioing the shared information and the usage smart contract in the entire network of the block chain;
receiving a rental request sent by a rental client and registering the rental request in the block chain network, wherein the rental request comprises personal information and rental requirements of a user who initiates the rental request;
calculating a user grade of the user who initiates the rental request according to a credit smart contract pre-stored in the block chain and the personal information;
searching matched shared vehicles according to a user grade and the rental requirements;
sending the matched shared vehicles to the rental client so that the rental client determines a target shared vehicle; and
releasing usage authorization of the target shared vehicle to the rental client.

Optionally, before said receiving shared information and the usage smart contract sent by the vehicle owner client, the method comprises:
issuing a service protocol of the shared vehicle, wherein the service protocol is configured to guide a vehicle owner of a shared vehicle to submit shared information and the usage smart contract; and
registering the service protocol and a service smart contract into the block chain network, wherein the service smart contract is generated according to the service protocol.

Optionally, the shared information comprises identity information of the vehicle owner, and after said receiving shared information and the usage smart contract sent by the vehicle owner client, the method further comprises:
performing identity authentication for the vehicle owner according to identity information of the vehicle owner;
assigning vehicular terminal and a vehicular terminal identifier to the shared vehicle of the vehicle owner according to the usage smart contract if the identity authentication is passed; and
registering the vehicular terminal into the block chain network as a node of the block chain network according to the vehicular terminal identifier.

Optionally, after said releasing usage authorization of the target shared vehicle to the rental client, the method comprises:
receiving usage data generated in a using process of the target shared vehicle, wherein the usage data are submitted by the vehicular terminal; and
registering the usage data into the block chain network.

Optionally, after said releasing usage authorization of the target shared vehicle to the rental client, the method further comprises:
classifying the usage data when a rental end request sent by the rental client is received;
determining ownership of the classified data according to classification attribute; and
sending the classified data to a corresponding ownership party.

Optionally, after said releasing usage authorization of the target shared vehicle to the rental client, the method further comprises:
calling the usage smart contract to submit a payment transaction request to the rental client when receiving the rental end request sent by the rental client;
calling the service smart contract to generate a income sharing solution according to incomes from the payment transaction after a payment transaction confirmation information of the rental client is received; and
sharing the incomes according to the income sharing solution.

The second aspect of the embodiment of the present application provides a server comprising:
a memory which stores executable computer program;
a processor coupled to the memory, wherein by calling the executable computer program in the memory, the processor is configured to:
receive shared information and a usage smart contract sent by a vehicle owner client;
register the shared information and the usage smart contract in a block chain network and radio the shared information and the usage smart contract in a entire network of the block chain;
receive a rental request sent by a rental client and register the rental request in the block chain network, wherein the rental request comprises personal information of the user who initiates the rental request and rental requirements;
calculate a user grade of the user initiating the rental request, according to the credit smart contract pre-stored in the block chains and the personal information;
search matched shared vehicles according to the user grade and the rental requirements;
send the matched shared vehicles to the rental client so that the rental client determines a target shared vehicle; and
release usage authorization of the target shared vehicle to the rental client.

Optionally, before said receiving shared information and the usage smart contract sent by the vehicle owner client, by calling the executable computer program in the memory, the processor is configured to:
issue a service protocol of the shared vehicle, wherein the service protocol is configured to guide a vehicle owner of the shared vehicle to submit the shared information and the usage smart contract; and
register the service protocol and a service smart contract in the block chain network, wherein the service smart contract is generated according to the service protocol.

Optionally, after said receiving shared information and a usage smart contract sent by a vehicle owner client, by calling the executable computer program in the memory the processor is further configured to:
perform identity authentication for the vehicle owner according to identity information of the vehicle owner;
assign a vehicular terminal and a vehicular terminal identifier to the shared vehicle of the vehicle owner according to the usage smart contract if the identity authentication is passed;
register the vehicular terminal into the block chain network as a node of the block chain network according to the vehicular terminal identifier.

Optionally, after said releasing usage authorization of the target shared vehicle to the rental client, by calling the executable computer program in the memory, the processor is further configured to:
receive usage data generated during a using process of the target shared vehicle, wherein the usage data is submitted by the vehicular terminal; and
register the usage data into the block chain network.

Optionally, after said releasing usage authorization of the target shared vehicle to the rental client, by calling the executable computer program in the memory, the processor is further configured to:
classify the usage data when a rental end request sent by the rental client is received;
determine ownership of the classified data according to classification attribute; and
send the classified data to a corresponding ownership party.

Optionally, after said releasing usage authorization of the target shared vehicle to the rental client, by calling the executable computer program in the memory, the processor is further configured to:
call the usage smart contract to initiate a payment transaction request to the rental client when receiving the rental end request sent by the rental client;
call the service smart contract to generate a income sharing solution according to incomes from the payment transaction after a payment transaction confirmation information of the rental client is received; and
share the incomes according the income sharing solution.

The third aspect of the embodiment of the present application provides a computer readable storage medium, the computer readable storage medium stores a computer program, wherein when the computer program is executed by a processor, the following steps are implemented:

shared information and a usage smart contract sent by a vehicle owner client is received;
the shared information and the usage smart contract are registered into a block chain network and the shared information and the usage smart contract are radioed in the entire network of the block chain;
a rental request sent by a rental client is received and the rental request is registered into the block chain network, wherein the rental request comprises personal information and rental requirements of a user who initiates the rental request;
a user grade of the user who initiates the rental request is calculated according to a credit smart contract pre-stored in the block chain and the personal information;
matched shared vehicles are searched according to a user grade and the rental requirements;
the matched shared vehicles are sent to the rental client so that the rental client determines a target shared vehicle; and
usage authorization of the target shared vehicle is released to the rental client.

Optionally, before said receiving shared information and the usage smart contract sent by the vehicle owner client, wherein the computer program is executed, the following steps are implemented:
a service protocol of the shared vehicle is issued, wherein the service protocol is configured to guide a vehicle owner of a shared vehicle to submit shared information and the usage smart contract; and
the service protocol and a service smart contract are registered into the block chain network, wherein the service smart contract is generated according to the service protocol.

Optionally, the shared information comprises identity information of the vehicle owner, and before said receiving shared information and the usage smart contract sent by the vehicle owner client, wherein the computer program is executed, the following steps are implemented:
identity authentication for the vehicle owner is performed according to identity information of the vehicle owner;
vehicular terminal and a vehicular terminal identifier are assigned to the shared vehicle of the vehicle owner according to the usage smart contract if the identity authentication is passed; and
the vehicular terminal is registered into the block chain network as a node of the block chain network according to the vehicular terminal identifier.

Optionally, after said releasing usage authorization of the target shared vehicle to the rental client, wherein the computer program is executed, the following steps are implemented:
usage data generated in a using process of the target shared vehicle is received, wherein the usage data are submitted by the vehicular terminal; and
the usage data is registered into the block chain network.

Optionally, after said releasing usage authorization of the target shared vehicle to the rental client, wherein the computer program is executed, the following steps are implemented:
the usage data is classified when a rental end request sent by the rental client is received;
ownership of the classified data is determined according to classification attribute; and
the classified data is sent to a corresponding ownership party.

Optionally, wherein after said releasing usage authorization of the target shared vehicle to the rental client, wherein the computer program is executed, the following steps are implemented:
the usage smart contract is called to submit a payment transaction request to the rental client when receiving the rental end request sent by the rental client;
the service smart contract is called to generate a income sharing solution according to incomes from the payment transaction after a payment transaction confirmation information of the rental client is received; and
the incomes is shared according to the income sharing solution.

In the embodiments of the present application, by registering information including received shared information sent by the vehicle owner client and personal information and rental requirements of the user sent by the rental client into a block chain network, such that the owner of the shared vehicle can obtain the real information of the user in time, and get to know the rental condition and the service condition of the his/her shared vehicle in each time period, so that the vehicle owner can share their own vehicles to various shared vehicle service platforms relievedly.

### BRIEF DESCRIPTION OF THE DRAWINGS

In order to interpret the technical solutions in embodiments of the present application more clearly, drawings needed to be used in the embodiments are briefly introduced hereinafter.

FIG. 1 is a structural schematic diagram of a system for managing shared vehicles provided by an embodiment of the present application;

FIG. 2 is a structural flow diagram of a method for managing shared vehicles provided by an embodiment of the present application;

FIG. 3 is a structural schematic diagram of a server provided by an embodiment of the present application.

### DETAILED DESCRIPTION OF THE ENABLING EMBODIMENTS

In order to enable technical problems, technical solutions, and beneficial effects of the present application to be clearer and more understandable, the present application will be further described in detail hereinafter with reference to the drawings and embodiments. In the description of the application, the terms “first” and “second” are used only for purposes of distinguishing description, and are not understood to indicate or imply the relative importance.

In order to illustrate the technical solutions disclosed in the present application, the technical solutions of the present application are described with reference to detailed embodiments below.

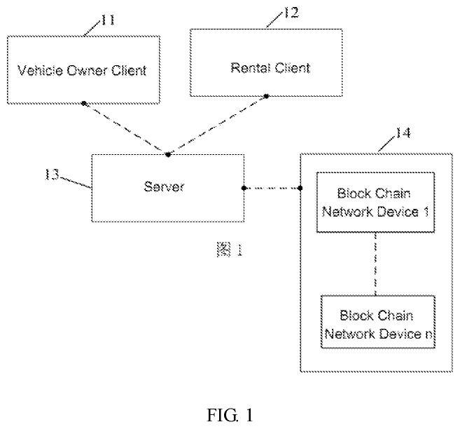

FIG. 1 is a structural schematic diagram of a system for managing shared vehicles provided by an embodiment of the present application, the system for managing shared vehicles comprises a vehicle owner client 11 and a rental client 12, a server 13 and a plurality of block chain network devices 14 serving as block chain nodes. The vehicle owner client 11, the rental client 12 and the block chain network devices 14 are respectively connected with the server 13. The vehicle owner client 11 is configured for sending shared information and a usage smart contract to the server 13, wherein the usage smart contract includes a using rule of the shared vehicle, and the shared information includes shared vehicle information and identity information of a vehicle owner of the shared vehicle. The rental client 12 is configured for sending a rental request to the server. The server 13 is configured for registering the received shared information and the usage smart contract in the block chain network devices 14 and radioing the shared information and the usage smart contract in the entire network of the block chain; the server 13 is further configured for searching matched shared vehicles according to the rental request of the rental client 12, so that a client of the rental client uses a target shared vehicle after the target shared vehicle is determined. The block chain network devices 14 are configured for receiving related data sent by the server 13 and storing the related data. Further, the vehicle owner client 11 and the rental client 12 can be one of intelligent terminals separately, such as a personal computer, a smart phone, a tablet computer, an intelligent wearable device or the like. The server 13 sends information to the block chain network devices 14, so that the block chain network devices register the information in the block chain for radioing the information in the entire network of the block chain, and the server can also be registered in the block chain to become a node device of the block chain.

### Embodiment 1

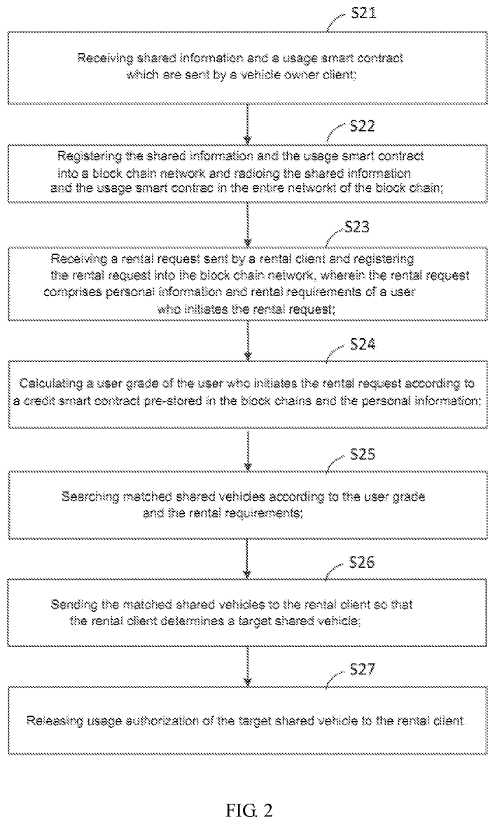

FIG. 2 shows a structural flow diagram of a method for managing shared vehicles provided by an embodiment of the present application, the above-mentioned method for managing shared vehicles comprises the Steps 21-27, detailed description is as follows:

S21, receiving shared information and a usage smart contract which are sent by a vehicle owner client.

In the embodiment provided by the present application, the server receives the shared information and the usage smart contract sent by the vehicle owner client, wherein the vehicle owner client is configured for receiving the information of the shared vehicle input by the vehicle owner of the shared vehicle and identity information of the vehicle owner, then the vehicle owner client is sending the information of the shared vehicle and the identity information of the vehicle owner to the server. The above-mentioned information of the shared vehicle includes information, such as the license plate number, the vehicle driving license, auto age, and the operation status of the engine, the running state of security devices and electronic devices and driving mileage and the like. The identity information of the vehicle owner includes one of, or more than one of the name of the vehicle owner, the identity number, contact information, etc. The usage smart contract specifies using rules for the shared vehicle, including a charging rule for using the shared vehicle, payment information, etc.

S22, registering the shared information and the usage smart contract into a block chain network and radioing the shared information and the usage smart contract in the entire network of the block chain.

The server sends the received shared information and the usage smart contract to the block chain network device, the block chain network device registers the shared information and the usage smart contract in the block chain and radios the shared information and the usage smart contract in the entire network of the block chain. Alternatively, when the server itself is a node device of the block chain, the server directly registers the received shared information and the usage smart contract in the block chain and radios to the entire network of the block chain, so that other block chain network devices may also obtain the same information, and indicating the other block chain network devices to store the received information. Optionally, when the server is sending the shared information and the usage smart contract to the block chain network, the shared information and the usage smart contract can be packaged before sending.

S23, receiving a rental request sent by a rental client and registering the rental request into the block chain network, wherein the rental request comprises personal information and rental requirements of a user initiating the rental request.

The server waits to receive the rental request sending by the rental client, if receiving the rental request, the server registers the rental request into the block chain network. The rental request includes personal information and rental requirements of the user sending the rental request. The personal information includes personal identifier, driving behavior preferences and the like, and the rental requirements includes information, such as vehicle type preferences, location information, cost budget information, etc.

S24, calculating a user grade of the user initiating the rental request according to a credit smart contract pre-stored in the block chain and the personal information.

After receiving the rental request, according to the personal identifier in the rental request, the server acquires specific user information such as driving behavior information, traffic violation information, driving mileage information, transaction information of using a shared vehicles, etc, stored in the block chain network. According to the specific user information mentioned above, the user grade of the user is calculated, wherein the user grade includes the user credit rating and driving levels, simultaneously considering together with the rental request from the user to find a matched shared vehicle.

Specifically, according to the ratio of the driving mileage of the user to violation behaviors or violation information within the driving mileage (e.g. corresponding violation behaviors or violation behavior times within 1000 kilometers of driving mileage), the credit rating can be determined. For example, it is provided that the basic credit rating of the user is average, and the user information shows that the user has a long driving mileage with no violation behaviors within the driving mileage and no traffic violation information, then it can be determined that the credit rating of the user is merit. If the user information shows the driving mileage of the user is short with no illegal behaviors within the driving mileage and no traffic violation information, or the ratio of the driving mileage of the user to the driving violation behaviors maintains in a low level. (e.g. the number of corresponding illegal behaviors or traffic violation behaviors is within 5 times within 1000 kilometers of driving mileage), then it may be determined that the credit rating of the user is average. If the user information shows the ratio of the driving mileage to the illegal behaviors and traffic violation information is relatively high (e.g. the number of corresponding illegal behaviors or traffic violation behaviors is more than 10 times within 1000 kilometers of driving mileage), then it is determined that the credit rating of the user is poor.

Specifically, according to the driving mileage and driving behavior information, the driving rating of the user can be determined. The longer the driving mileage with the fewer number of driving violation in corresponding driving behavior information, the driving rating of the user will be higher.

S25, searching matched shared vehicles according to the user grade and the rental requirements.

The calculated user grade (credit rating and driving level) can be used to determine the range of the matched shared vehicle of the user, including a charging range, a vehicle type range, and the like, and considering together with the rental requirements of the user, such as vehicle type preferences, location information, cost budget, etc, the matched shared vehicle is determine, so that the information of the matched shared vehicle is provided to the user.

S26, sending the matched shared vehicles to the rental client so that the rental client determines a target shared vehicle.

S27, releasing usage authorization of the target shared vehicle to the rental client.

According to the calculation of the user grade of the user initiating the rental request, searching proper shared vehicles among shared vehicles, and sending the information of the found target share vehicles to the rental client for the user to select. If receiving the selection information of target share vehicle sending from the rental client, then the usage authorization of the target shared vehicle is released to the user. Specifically, the specific manner of releasing the usage authorization of the target shared vehicle to the user can be directly controlling the target shared vehicle doors to be unlocked, and the engine to be in an available state. Alternatively, controlling password of the target shared vehicle also can be sent to the rental client, and according to the controlling password, the user unlocks the vehicle doors and starts the engine, so as to obtain the usage authorization of the shared vehicle.

It should be noted that, the above-mentioned data is stored in the block chain network in a form of a block. Each block comprises two parts, a block header and a block body, wherein the block header is configured to record characteristic values of the current block, and the block body is actual data. The block header includes a plurality of characteristic values of the current block. The plurality of characteristic values comprises: generating time, the hash value of the block body and the hash value of the last block. The hash value of a block is calculated according to the block header. That is, each of the characteristic values of the block header is sequentially connected together to form a long character string, and then calculating the hash value of the character string, thus the hash value of each block is not the same, identifying the block via hash.

Since block header contains many contents, the contents include a hash of the current block body and the hash of the last block. Since the consensus mechanism of the block chain, modifying a plurality of blocks within a short time is almost impossible to happen, unless more than 51% of the computing ability of the entire network of the block chain is mastered. So that de-centering and non-tampered characteristics of the block chain are formed.

Thus, in the embodiment of the present application, utilizing the de-centering and non-tampered characteristics of the data in the block chain, information of usage data and transaction data and other information produced in the process of the vehicle rental is sent to the node devices of the block chain for storage, which guarantees that the vehicle owner obtains the true vehicle usage data and transaction data, so that the vehicle owner can share the vehicle to others through a service platform in a block chain with confidence.

Additionally, the smart contract is a executable computer program which can execute contract clauses automatically. It does not generate smart contract, and will not modify the smart contract; its presence is only intended to correctly perform a group of complex digitized commitments with trigger conditions according to the will of the participants. Thus, after the smart contract deployed in the block chain, the smart contract waits to be called, but cannot be changed.

A large number of smart contracts are typically deployed in the block chain, wherein the smart contract is with an identifier for identifying the smart contract. Alternatively, the identifier of the smart contract may be the name of the smart contract, and the identifier is configured to uniquely identify the smart contract deployed in the block chain. Thus, information sent by the user terminal to the block chain may carry identifiers of different smart contracts, so that after the block chain network received relevant data carrying the identifier information of the smart contracts, corresponding smart contract may be called to execute corresponding program.

Optionally, in another embodiment provided by the present application, before the receiving shared information and the usage smart contract sent by the vehicle owner client, the method for managing shared vehicles further includes:

A service protocol of the shared vehicle is issued, wherein the service protocol is configured to guide the owner of the shared vehicle to submit the shared information and usage smart contract;

A service protocol and a service smart contract are registered in the block chain network; wherein the service smart contract is generated according to the service protocol.

In this embodiment, in order to encourage more owners to share their own vehicles, the server will release the service protocol of the shared vehicle in advance so as to guide the vehicle owner to submit the shared information and usage smart contract according to the service protocol. For example, the basic requirements of the shared vehicle (such as the vehicle age, the driving route and the like) of the shared vehicle can be specified in the service protocol, and the requirements for the vehicle owner authentication (such as what information can only be used for authenticating the identity of the vehicle owner) and the like.

Optionally, the server can also install the vehicular terminal for the shared vehicle whose vehicle owner is passed the authentication, wherein the service protocol may further comprise a request manner for installing the vehicular terminal, a charging rule for installing the vehicular terminal and the like. In addition, the service protocol is further used for informing the vehicle owner that running data of the shared vehicle will also be registered into the block chain network. The server issues the service protocol and specifies a service smart contract according to the service protocol, so as to conveniently send a check for the shared information to the vehicle owner hereinafter. The server registers the issued service protocol and the service smart contract in the block chain network.

Optionally, in another embodiment provided by the present application, the shared information comprises the identity information of the vehicle owner, and after said shared information and the usage smart contract sent by the vehicle owner client is received, the method further comprises:

Identity authentication is carried out on the vehicle owner according to the identity information of the vehicle owner;

If the authentication is passed, the vehicular terminal and the vehicular terminal identifier are distributed to the shared vehicle of the vehicle owner according to the usage smart contract;

The vehicular terminal is registered in a block chain network as a node of the block chain network according to the vehicular terminal identifier.

In the embodiment of the present application, in order to ensure the safety of the shared vehicle, the identity of the vehicle owner is authenticated. For example, the ownership relation between the sender of the shared information and the shared vehicle can be determined according to the information contained in the vehicle driving certificate of the shared vehicle. The information contained in the vehicle driving certificate included in the shared information sent by the vehicle owner client. If the identity of the sender (vehicle owner) passes authentication, the vehicular terminal and the vehicular terminal identifier are distributed to the shared vehicle. The vehicular terminal is configured to record and send the usage data of the vehicle during the using process to the vehicle owner client and the rental client; the vehicular terminal identifier is configured to carry out unique identifier on the vehicular terminal of different shared vehicles distributed by the user terminal; and recording the vehicular terminal as a node of the node devices in a block chain, so as to upload the usage data generated during the using process of the shared vehicle to the block chain timely.

Optionally, in another embodiment provided in the present application, after the usage authorization of the target shared vehicle is released to the rental client, the method comprises the following steps:

The usage data generated during the using process of the target shared vehicle is received, wherein the usage data are submitted by the vehicular terminal;

The usage data is registered in the block chain network.

In the embodiment of the present application, if the server releases the usage authorization of the target shared vehicle to the rental client, the vehicular terminal monitors the usage data generated during the using process of the target shared vehicle in real time. The usage data can be data generated during the process that the user drives the target share vehicle, wherein the usage data includes: service time of the target shared vehicle, the driving track and the driving behavior (such as a sharp turn), the lane change and other data, and the working condition data (such as the vehicle speed, acceleration, engine data flow, gearbox data flow) of the target shared vehicle during the using process) and the like. The vehicular terminal sends the collected usage data to the server. If the server receives the usage data of the target shared vehicle, the usage data is sent to the block chain network for storage.

Optionally, in another embodiment provided by the present application, after the usage authorization of the target shared vehicle is released to the rental client, the method further comprises:

When a rental end request sent by the rental client is received, classifying the usage data; determining the ownership of the classified data according to the classification attributes;

The classified data is sent to the corresponding ownership party.

In the embodiment of the present application, if the user finishes renting the target shared vehicle, the server determines the usage data in the using process according to the end instruction from the user on the basis of the real-time uploaded usage data, and the usage data are classified according to attributes. For example, data such as the service time of the target shared vehicle, the driving track, and driving behavior and the like are determined as driving data; the speed of the vehicle, acceleration data, engine data, gearbox data and the like are determined as vehicle condition data. The ownership of the classified data is determined according to the classification attributes of the usage data. For example, the ownership of the driving data belonging to a user initiating a rental request is determined, and the ownership of the vehicle condition data belonging to the vehicle owner is determined. After the ownership is determined, the classified data is sent to the corresponding ownership party, and meanwhile, the ownership marking is carried out. For example, the driving data is sent to the user, and the vehicle condition data is sent to the vehicle owner, and the ownership marking is carried out by marking or adding a watermark.

Optionally, in another embodiment provided by the present application, after the usage authorization of the target shared vehicle is released to the rental client, the method further comprises:

When a rental end request sent by the rental client is received, the usage smart contract is called to initiate a payment transaction request to the rental client;

After the payment transaction confirmation information from the rental client is received, a service smart contract is called to generate an income sharing solution generated according to the payment transaction;

Incomes are shared according to the income sharing solution.

In this embodiment, when the user initiating the rental request ends the rental of the target shared vehicle, the server calls the usage smart contract of the shared vehicle to initiate a payment transaction request to the rental client, wherein the travel list and the charging detail of the process are provided for the user to complete the payment transaction according to the travel list and the charging detail. After the user finishes the payment transaction, the rental client sends confirmation information of the payment transaction to the server. At the moment, the server calls the service smart contract to form an income sharing solution according to the payment amount, and allocating incomes to the related parties according to the income sharing solution. Due to the fact that the operator of the server also provides a corresponding service in the transaction process, and therefore the income sharing solution is mainly distributed between the vehicle owner and the operator. For example, the owner is distributed with 90% amount of the payment, and the operator of the server is allocated with 10% amount of the payment. Then, the corresponding amount of the payment is transferred to the account corresponding to the vehicle owner and the operator according to the income sharing solution. The present application is only embodied herein, and may other various income sharing solution can be provided, however, which are not specifically limited herein. If events such as traffic violation are generated during the rental process, according to the service smart contract, performing post-processing on events such as the traffic violation and the like. For example, the traffic violation fee is charged from the user.

In the embodiments of the present application, information such as the received shared information sent by the vehicle owner client and the personal information of the user, the rental request and the like sent by the rental client are registered in the block chain network, so that the vehicle owner of the shared vehicle can obtain the real information of the user in time, and know the rental and using conditions of the vehicles which are shared by themselves in each time period, so that the vehicle owner shares their own vehicle to the every service platform of the shared vehicle relievedly, the enthusiasm of the vehicle owner in sharing vehicles is improved, and the sharing and using efficiency of a vehicle is also improved.

### Embodiment 2

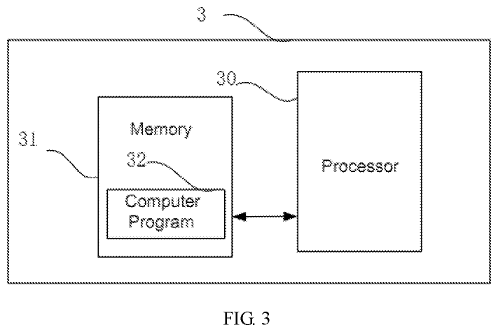

FIG. 3 is a structural schematic diagram of a server according to an embodiment of the present application. The server 3 provided by the embodiment comprises a processor 30, a memory 31, and a computer program 32 stored in the memory 31 and capable of running in the processor 30. For example, a program in the method for managing shared vehicles. The processor 30 implements the steps in the embodiments of above-mentioned method for managing shared vehicles when executing the computer program 32, such as the step 21 to the step 26 shown in FIG. 2. When the processor 30 executes the computer program 32, the steps 21 to 26 shown in FIG. 2 are implemented.

The server may include, but is not limited to, a processor 30 and a memory 31. Those skilled in the art should understand that FIG. 3 is merely an example of the terminal device 3, which is not a limitation to the server 3. More or fewer components than shown in FIG. 3 may be included, or some components may be combined, or different components may be combined. For example, the sever 3 may further includes an input/output device, a network access device, a bus and the like.

The processor 30 may be a central processing unit (CPU), and can also be other general-purpose processors, a digital signal processor (DSP), an application specific integrated circuit (ASIC), a field-programmable gate array (FPGA) or other programmable logic devices, discrete gate or transistor logic devices, discrete hardware components and the like. The general-purpose processor may be a microprocessor or the processor may be any conventional processor or the like.

The memory 31 may be an internal storage unit of the server 3, such as a hard disk or a memory of the server 3. The memory 31 may also be an external storage device of the server 3, for example, a plug-in type hard disk arranged to the server 3, a smart media card (SMC), a secure digital (SD) card, a flash card and the like. Further, the memory 31 may also include both an internal storage unit and an external storage device of the server 3. The memory 31 is configured to store the computer program and other programs and data needed by the insurance. The memory 31 may also be used to temporarily store data that has been output or to be output.

As an embodiment, when the server is carrying out a service transaction of shared vehicle, the processor 30 executes the computer program 32 stored in the memory 31, the processor is configured to: Shared information and usage smart contract sent by a vehicle owner client is received; The shared information and the usage smart contract are registered in a block chain network and the shared information and the usage smart contract are radioed in the entire network of the block chain; A rental request sent by the rental client is received and registered in the block chain network, wherein the rental request comprises personal information and rental requirements from the user initiating the rental request; According to a credit smart contract pre-stored in the block chain and the personal information, a user grade of a user initiating the rental request is calculated; Matched shared vehicles according to the user grade and the rental requirements is searched; The matched shared vehicles are sent to the rental client, so that the rental client determines a target shared vehicle; A usage authorization of the target shared vehicle are released to the rental client.

Optionally, before the shared information and the usage smart contract sent by the vehicle owner client is received, the processor calls executable computer programs in the memory, the processor is further configured to: A service protocol of the shared vehicle is issued, and the service protocol is configured to guide the owner of the shared vehicle to submit the shared information and usage smart contract; The service protocol and the service smart contract are registered in the block chain network, and the service smart contract is generated according to the service protocol.

Optionally, after the shared information and usage smart contract sent by the vehicle owner client is received, the processor calls executable computer programs in the memory, the processor is further configured to: Identity authentication on the vehicle owner is carried out according to the identity information of the vehicle owner; If the identity authentication is passed, the vehicular terminal and the vehicular terminal identifier are distributed to a shared vehicle of the vehicle owner according to the usage smart contract; The vehicular terminal is registered in a block chain network as a node of the block chain network according to the vehicular terminal identifier.

Optionally, after the usage authorization of the target shared vehicle is released to the rental client, the processor calls executable computer programs in the memory, the processor is further configured to: The usage data generated by the target shared vehicle in a using process is received, wherein the usage data are submitted by the vehicular terminal; The usage data is registered in the block chain network.

Optionally, after the usage authorization of the target shared vehicle is released to the rental client, the processor calls executable computer programs in the memory, the processor is further configured to: When a rental end request sent by the rental client is received, the usage data is classified; the ownership of the classified data is determined according to the classification attributes; The classified data is sent to the corresponding ownership party.

Optionally, after the usage authorization of the target shared vehicle is released to the rental client, the processor calls executable computer programs in the memory, the processor is further configured to: When the rental end request sent by the rental client is received, calling the usage smart contract to initiate a payment transaction request to the rental client; After the payment transaction confirmation information of the rental client is received, calling a service smart contract to generate an income sharing solution according to the payment transaction; According to the income sharing solution, the incomes are shared. The computer program 32 may be partitioned into one or more units/modules, the one or more units/modules are stored in the memory 31, and the computer program is executed by the processor 30 so as to complete the application.

The server 3 can be a cloud server, an intelligent device, a computer, a notebook computer, a hand-held computer or other computing devices. The server 3 may include, but is not limited to, the processor 30, the memory 31. Those skilled in the art should understand that FIG. 3 is only an example of the server 3, which is a limitation to the server 3, it may include more or fewer components than shown in FIG. 3, or combine certain components, or different components. For example, the server 3 can further comprise input/output devices, network access devices, a bus and the like. The processor 30 may be a central processing unit (CPU), and can also be other general-purpose processors, a digital signal processor (DSP), an application specific integrated circuit (ASIC), a field-programmable gate array (FPGA) or other programmable logic devices, discrete gate or transistor logic devices, discrete hardware components and the like. The general-purpose processor may be a microprocessor or the processor may be any conventional processor or the like.

The memory 31 may be an internal storage unit of the server 3, such as a hard disk or a memory of the server 3. The memory 31 may also be an external storage device of the server 3, such as a plug-in type hard disk arranged to the server 3, a smart media card (SMC), a secure digital (SD) card, a flash card and the like. Further, the memory 31 may also include both the internal storage unit and the external storage device of the server 3. The memory 31 is configured to store the computer program and other programs and data needed by the server 3. The memory 31 may also be configured to temporarily store data that has been output or to be output.

Those skilled in the art can clearly understand that for convenient and concise of the description, the specific working procedures described above can be referred to the corresponding processes in the preceding method embodiments, and are not described in detail herein. In several embodiments provided herein, it should be appreciated that, the system, the data management server and the method disclosed by the present application can be realized in other manners. The units illustrated as separate components may or may not be physically separate, the component displayed as a unit can be or may not be a physical element. According to actual requirements, some or all of the units can be selected to achieve the purpose of the solutions of the embodiment.

In embodiment 3 of the present application, if the function is implemented in a form of a software functional unit and sold or used as an independent product, it can be stored in a computer readable storage medium. Based on such understanding, the technical solutions of the present application are essentially, or the part contributing to the prior art or part of the technical solution, can be embodied in the form of a software product. The computer software product is stored in a storage medium, wherein instructions are included and used for enabling a computer device (can be a personal computer, a server, a network device or the like) to implement all or part of the steps of the method disclosed by the embodiment of the present application. The storage medium comprises a medium storing program codes, such as a USB flash disk, a removable hard disk, a read-only memory (ROM), a random access memory (RAM), a magnetic disk, an optical disk or the like.

The computer readable storage medium stores a computer program, when the computer program is executed by the processor, the following steps are implemented:

Receiving shared information sent by the vehicle owner client and usage smart contract; The shared information and the usage smart contract are registered in a block chain network and radioing in the entire network of the block chain;

A rental request sent by the rental client is received and registered in the block chain network, wherein the rental request comprises personal information of the user initiating the rental request and rental requirements;

According to a credit smart contract pre-stored in the block chain and the personal information, a user grade of the user initiating the rental request is calculated;

Matched shared vehicles are searched according to the user grade and the rental requirements;

The matched shared vehicle is sent to the rental client, so that the rental client determines the target shared vehicle;

The usage authorization of the target shared vehicle are released to the rental client.

Optionally, before said receiving shared information and the usage smart contract sent by the vehicle owner client, wherein the computer program is executed, the following steps are implemented:
a service protocol of the shared vehicle is issued, wherein the service protocol is configured to guide a vehicle owner of a shared vehicle to submit shared information and the usage smart contract; and
the service protocol and a service smart contract are registered into the block chain network, wherein the service smart contract is generated according to the service protocol.

Optionally, the shared information comprises identity information of the vehicle owner, and before said receiving shared information and the usage smart contract sent by the vehicle owner client, wherein the computer program is executed, the following steps are implemented:
identity authentication for the vehicle owner is performed according to identity information of the vehicle owner;
vehicular terminal and a vehicular terminal identifier are assigned to the shared vehicle of the vehicle owner according to the usage smart contract if the identity authentication is passed; and
the vehicular terminal is registered into the block chain network as a node of the block chain network according to the vehicular terminal identifier.

Optionally, after said releasing usage authorization of the target shared vehicle to the rental client, wherein the computer program is executed, the following steps are implemented:
usage data generated in a using process of the target shared vehicle is received, wherein the usage data are submitted by the vehicular terminal; and
the usage data is registered into the block chain network.

Optionally, after said releasing usage authorization of the target shared vehicle to the rental client, wherein the computer program is executed, the following steps are implemented:
the usage data is classified when a rental end request sent by the rental client is received;
ownership of the classified data is determined according to classification attribute; and
the classified data is sent to a corresponding ownership party.

Optionally, wherein after said releasing usage authorization of the target shared vehicle to the rental client, wherein the computer program is executed, the following steps are implemented:
the usage smart contract is called to submit a payment transaction request to the rental client when receiving the rental end request sent by the rental client;
the service smart contract is called to generate a income sharing solution according to incomes from the payment transaction after a payment transaction confirmation information of the rental client is received; and
the incomes is shared according to the income sharing solution.

The descriptions mentioned above are only preferred embodiments of the present application, and are not intended to limit the present application. Any modification, equivalent replacement, improvement and the like, which are made within the spirit and principle of the present application, should all be included in the protection scope of the present application.

1. A method for managing shared vehicles comprising:
receiving shared information and a usage smart contract sent by a vehicle owner client;
registering the shared information and the usage smart contract into a block chain network and radioing the shared information and the usage smart contract in the entire network of the block chain;
receiving a rental request sent by a rental client and registering the rental request in the block chain network, wherein the rental request comprises personal information and rental requirements of a user who initiates the rental request;
calculating a user grade of the user who initiates the rental request according to a credit smart contract pre-stored in the block chain and the personal information;
searching matched shared vehicles according to a user grade and the rental requirements;
sending the matched shared vehicles to the rental client so that the rental client determines a target shared vehicle; and
releasing usage authorization of the target shared vehicle to the rental client.

2. The method for managing shared vehicles as claimed in claim 1, wherein before said receiving shared information and the usage smart contract sent by the vehicle owner client, the method further comprises:
issuing a service protocol of the shared vehicle, wherein the service protocol is configured to guide a vehicle owner of a shared vehicle to submit shared information and the usage smart contract; and
registering the service protocol and a service smart contract into the block chain network, wherein the service smart contract is generated according to the service protocol.

3. The method for managing shared vehicles as claimed in claim 1, wherein the shared information comprises identity information of the vehicle owner, and after said receiving shared information and the usage smart contract sent by the vehicle owner client, the method further comprises:
performing identity authentication for the vehicle owner according to identity information of the vehicle owner;
assigning vehicular terminal and a vehicular terminal identifier to the shared vehicle of the vehicle owner according to the usage smart contract if the identity authentication is passed; and
registering the vehicular terminal into the block chain network as a node of the block chain network according to the vehicular terminal identifier.

4. The method for managing shared vehicles as claimed in claim 3, wherein after said releasing usage authorization of the target shared vehicle to the rental client, the method further comprises:
receiving usage data generated in a using process of the target shared vehicle, wherein the usage data are submitted by the vehicular terminal; and
registering the usage data into the block chain network.

5. The method for managing shared vehicles as claimed in claim 4, wherein after said releasing usage authorization of the target shared vehicle to the rental client, the method further comprises:
classifying the usage data when a rental end request sent by the rental client is received;
determining ownership of the classified data according to classification attribute; and
sending the classified data to a corresponding ownership party.

6. The method for managing shared vehicles as claimed in claim 1, wherein after said releasing usage authorization of the target shared vehicle to the rental client, the method further comprises:
calling the usage smart contract to submit a payment transaction request to the rental client when receiving the rental end request sent by the rental client;
calling the service smart contract to generate a income sharing solution according to incomes from the payment transaction after a payment transaction confirmation information of the rental client is received; and
sharing the incomes according to the income sharing solution.

7. A server comprising:
a memory which stores executable computer program;
a processor coupled to the memory, wherein by calling the executable computer program in the memory, the processor is configured to:
receive shared information and a usage smart contract sent by a vehicle owner client;
register the shared information and the usage smart contract in a block chain network and radio the shared information and the usage smart contract in a entire network of the block chain;
receive a rental request sent by a rental client and register the rental request in the block chain network, wherein the rental request comprises personal information of the user who initiates the rental request and rental requirements;
calculate a user grade of the user initiating the rental request, according to the credit smart contract pre-stored in the block chains and the personal information;
search matched shared vehicles according to the user grade and the rental requirements;
send the matched shared vehicles to the rental client so that the rental client determines a target shared vehicle; and
release usage authorization of the target shared vehicle to the rental client.

8. The server as claimed in claim 7, wherein before said receiving shared information and the usage smart contract sent by the vehicle owner client, by calling the executable computer program in the memory, the processor is further configured to:
issue a service protocol of the shared vehicle, wherein the service protocol is configured to guide a vehicle owner of the shared vehicle to submit the shared information and the usage smart contract; and
register the service protocol and a service smart contract in the block chain network, wherein the service smart contract is generated according to the service protocol.

9. The server as claimed in claim 7, wherein after said receiving shared information and a usage smart contract sent by a vehicle owner client, by calling the executable computer program in the memory the processor is further configured to:
perform identity authentication for the vehicle owner according to identity information of the vehicle owner;
assign a vehicular terminal and a vehicular terminal identifier to the shared vehicle of the vehicle owner according to the usage smart contract if the identity authentication is passed;
register the vehicular terminal into the block chain network as a node of the block chain network according to the vehicular terminal identifier.

10. The server as claimed in claim 9, wherein after said releasing usage authorization of the target shared vehicle to the rental client, by calling the executable computer program in the memory, the processor is further configured to:
receive usage data generated during a using process of the target shared vehicle, wherein the usage data is submitted by the vehicular terminal; and
register the usage data into the block chain network.

11. The server as claimed in claim 10, wherein after said releasing usage authorization of the target shared vehicle to the rental client, by calling the executable computer program in the memory, the processor is further configured to:
classify the usage data when a rental end request sent by the rental client is received;
determine ownerships of the classified data according to classification attribute; and
send the classified data to a corresponding ownership party.

12. The server as claimed in claim 7, wherein after said releasing usage authorization of the target shared vehicle to the rental client, by calling the executable computer program in the memory, the processor is further configured to:
call the usage smart contract to initiate a payment transaction request to the rental client when receiving the rental end request sent by the rental client;
call the service smart contract to generate a income sharing solution according to incomes from the payment transaction after a payment transaction confirmation information of the rental client is received; and
share the incomes according the income sharing solution.

13. A computer readable storage medium which stores a computer program, wherein when the computer program is executed, the following steps are implemented:
shared information and a usage smart contract sent by a vehicle owner client is received;
the shared information and the usage smart contract are registered into a block chain network and the shared information and the usage smart contract are radioed in the entire network of the block chain;
a rental request sent by a rental client is received and the rental request is registered into the block chain network, wherein the rental request comprises personal information and rental requirements of a user who initiates the rental request;
a user grade of the user who initiates the rental request is calculated according to a credit smart contract pre-stored in the block chain and the personal information;
matched shared vehicles are searched according to a user grade and the rental requirements;
the matched shared vehicles are sent to the rental client so that the rental client determines a target shared vehicle; and
usage authorization of the target shared vehicle is released to the rental client.

14. The computer readable storage medium which stores a computer program as claimed in claim 13, before said receiving shared information and the usage smart contract sent by the vehicle owner client, wherein the computer program is executed, the following steps are implemented:
a service protocol of the shared vehicle is issued, wherein the service protocol is configured to guide a vehicle owner of a shared vehicle to submit shared information and the usage smart contract; and
the service protocol and a service smart contract are registered into the block chain network, wherein the service smart contract is generated according to the service protocol.

15. The computer readable storage medium which stores a computer program as claimed in claim 13, wherein the shared information comprises identity information of the vehicle owner, and before said receiving shared information and the usage smart contract sent by the vehicle owner client, wherein the computer program is executed, the following steps are implemented:
identity authentication for the vehicle owner is performed according to identity information of the vehicle owner;
vehicular terminal and a vehicular terminal identifier are assigned to the shared vehicle of the vehicle owner according to the usage smart contract if the identity authentication is passed; and
the vehicular terminal is registered into the block chain network as a node of the block chain network according to the vehicular terminal identifier.

16. The computer readable storage medium which stores a computer program as claimed in claim 15, after said releasing usage authorization of the target shared vehicle to the rental client, wherein the computer program is executed, the following steps are implemented:
usage data generated in a using process of the target shared vehicle is received, wherein the usage data are submitted by the vehicular terminal; and
the usage data is registered into the block chain network.

17. The computer readable storage medium which stores a computer program as claimed in claim 16, after said releasing usage authorization of the target shared vehicle to the rental client, wherein the computer program is executed, the following steps are implemented:
the usage data is classified when a rental end request sent by the rental client is received;
ownership of the classified data is determined according to classification attribute; and
the classified data is sent to a corresponding ownership party.

18. The computer readable storage medium which stores a computer program as claimed in claim 13, wherein after said releasing usage authorization of the target shared vehicle to the rental client, wherein the computer program is executed, the following steps are implemented:
the usage smart contract is called to submit a payment transaction request to the rental client when receiving the rental end request sent by the rental client;
the service smart contract is called to generate a income sharing solution according to incomes from the payment transaction after a payment transaction confirmation information of the rental client is received; and
the incomes is shared according to the income sharing solution.
